(19) United States
(12) Patent Application Publication
(10) Pub. No.: US 2013/0083791 A1
(43) Pub. Date: Apr. 4, 2013

(54) METHOD OF UPDATING A TIME SYNCHRONIZATION REFERENCE

(71) Applicants: Sébastien Jobert, Begard (FR); Fabrice Bourgart, Perros Guirec (FR)

(72) Inventors: Sébastien Jobert, Begard (FR); Fabrice Bourgart, Perros Guirec (FR)

(73) Assignee: France Telecom, Paris (FR)

(21) Appl. No.: 13/701,356

(22) PCT Filed: May 27, 2011
(86) PCT No.: PCT/FR11/51209

§ 371 Date: Nov. 30, 2012

(30) Foreign Application Priority Data
May 31, 2010 (FR) 10 54216

(51) Int. Cl. H04W 56/00

(52) U.S. Cl. CPC H04W 56/001
USPC 370/350

(57) ABSTRACT

A method and apparatus are provided for updating a temporal synchronization reference exchanged between a first item of equipment and at least one second item of equipment belonging to a communication network. The method includes the following steps implemented by one of the two items of equipment: a step of receiving a traceability cue relating to a frequency-synchronization reference; a step of determining the periodicity of updating of the temporal synchronization reference as a function of said traceability cue received. The updating makes it possible to maintain the temporal synchronization reference of the second item of equipment.

### CROSS-REFERENCE TO RELATED APPLICATIONS

This Application is a Section 371 National Stage Application of International Application No. PCT/FR2011/051209, filed May 27, 2011, which is incorporated by reference in its entirety and published as WO 2011/151576 on Dec. 8, 2011, not in English.

### STATEMENT REGARDING FEDERALLY SPONSORED RESEARCH OR DEVELOPMENT

None.

### THE NAMES OF PARTIES TO A JOINT RESEARCH AGREEMENT

None.

### FIELD OF THE DISCLOSURE

The present disclosure lies in the field of telecommunications, and more particularly to that of mobile networks, e.g. such as long-term evolution (LTE) networks. Such networks are revealing a need to provide for the base stations forming parts of a mobile telecommunications network to have common time synchronization with accuracy of microsecond (μs) order.

### BACKGROUND OF THE DISCLOSURE

The difficulty of supplying such time synchronization without using satellite solutions such as global positioning system (GPS) modules, has required precision time protocols (PTPs) to be developed specifically for timing, such as PTPv2.

In order to provide that type of time synchronization, it is known to combine time synchronization with frequency synchronization that is stable and accurate, as happens when it is transported by the physical layer, e.g. by means of a technique such as the “synchronous Ethernet”.

It is thus possible for a piece of network equipment to maintain its time synchronization reference on the basis of the frequency synchronization between two time updates of its time synchronization.

Nevertheless, the accuracy of the frequency synchronization might change, e.g. as a result of drift in the frequency synchronization or as a result of a failure in the network. This degrades the synchronization between the various pieces of equipment forming parts of the network. This has the consequence of causing numerous time synchronization update messages to be sent to the various pieces of equipment in the network in order to ensure continuity of service.

### SUMMARY

An embodiment of the invention provides an updating method for updating a time synchronization reference exchanged between a first piece of equipment and at least one second piece of equipment forming parts of a communications network, the method comprising a determination step of determining a periodicity for updating the time synchronization reference as a function of traceability information relating to a frequency synchronization reference enabling the time synchronization reference of the second piece of equipment to be maintained.

By adapting the periodicity for updating the time synchronization reference, such a solution makes it possible to reduce the quantity of data exchanged over the network in order to maintain the time synchronization reference of the second piece of equipment. A time synchronization reference includes data enabling the second piece of equipment to be synchronized in time and/or in phase.

The traceability information relating to a frequency synchronization reference includes an indication about the quality and the accuracy of the frequency synchronization used for maintaining the time synchronization reference of the second piece of equipment between two updates.

Such an indication about quality and accuracy makes it possible to know whether the frequency synchronization reference is traceable to a primary reference clock (PRC), i.e. that the frequency synchronization reference is of good quality, or to a synchronization supply unit (SSU), i.e. that the frequency synchronization reference is of poorer quality.

Such a solution is also advantageous in the event of an interruption in the transmission of the time synchronization reference.

In such a situation, the frequency synchronization reference makes it possible to maintain the time synchronization reference of the second piece of equipment throughout the duration of the failure, thus ensuring continuity of service.

Such a solution makes it possible in particular to replace a mechanism for protecting the transmission of the time synchronization reference, in particular if the period over which synchronization is maintained is long enough to enable the failure to be dealt with. It is then possible to avoid deploying a second primary time synchronization source in order to replace the first primary synchronization source in the event of it failing.

In one implementation, prior to the determination step, the method includes a reception step of receiving the traceability information.

The traceability information makes it possible almost instantaneously to determine the periodicity for updating the time synchronization reference, and thus to respond quickly to any failures relating to the frequency synchronization.

According to a characteristic of the updating method, the traceability information is sent by the second piece of equipment to the first piece of equipment.

In such an implementation, the frequency synchronization reference may be delivered, for example, by a frequency synchronization reference source forming part of the second piece of equipment. A second piece of equipment that knows the traceability information relating to a frequency synchronization reference transmits this information to the first piece of equipment that then determines the periodicity for updating the time synchronization reference.

According to a characteristic of the updating method, the reception and determination steps are performed by the second piece of equipment, the method also including a step of the second piece of equipment transmitting a message to the first piece of equipment, the message including the periodicity for updating the time synchronization reference.

In such an implementation, since the frequency synchronization reference is delivered by a traceability synchronization reference source forming part of the second piece of equipment, the second piece of equipment determines the periodicity for updating the time synchronization reference. The second piece of equipment informs the first piece of equipment of the periodicity for updating the time synchronization reference it is to receive, e.g. by directly relaying the traceability information relating to the frequency synchronization reference or else by explicitly giving the periodicity value it has determined.

According to a characteristic of the updating method, the reception and determination steps are performed by the first piece of equipment, and the method further includes a step of sending the frequency synchronization reference and the associated traceability information to the second piece of equipment.

An embodiment of the invention also provides a piece of equipment suitable for exchanging a time synchronization reference with at least one other piece of equipment forming parts of a communications network, the piece of equipment including determination means for determining the periodicity for updating the time synchronization reference as a function of traceability information relating to a frequency synchronization reference enabling the time synchronization reference of the other piece of equipment to be maintained.

By way of example, such a piece of equipment consists in an optical line termination (OLT) forming part of a passive optical access network (PON).

According to a characteristic of the equipment, it also includes reception means for receiving traceability information relating to the frequency synchronization reference.

According to a characteristic of the equipment, it further including means for transmitting a message containing the periodicity for updating the time synchronization reference.

An embodiment of the invention also provides a communications network including at least a first piece of equipment suitable for exchanging a time synchronization reference with at least one second piece of equipment, the first piece of equipment having reception means for receiving the traceability information relating to the frequency synchronization reference and determination means for determining the periodicity for updating the time synchronization reference as a function of traceability information relating to a frequency synchronization reference enabling the time synchronization reference of the second piece of equipment to be maintained.

In other aspects, an embodiment of the invention also provides a computer program having program code instructions for implementing steps of the method of updating a time synchronization reference exchanged between a first piece of equipment and at least one second piece of equipment forming parts of a communications network, as described above, when these programs are executed by a computer.

The above-described computer program may use any programming language and may be in the form of source code, object code, or code intermediate between source code and object code, such as in a partially compiled form, or in any other desirable form.

An embodiment of the invention also provides a computer readable recording medium on which a computer program as described above is recorded.

The data medium may be any entity or device capable of storing the program. For example, the medium may comprise storage means such as read only memory (ROM), e.g. a compact disk (CD) ROM or a microelectronic circuit ROM, or it may comprise magnetic recording means, e.g. a floppy disk or a hard disk.

Furthermore, the information medium may be a transmissible medium such as an electrical or optical signal, suitable for being conveyed via an electrical or optical cable, by radio, or by other means. The program of an embodiment of the invention may in particular be downloaded from an Internet type network.

Alternatively, the data medium may be an integrated circuit in which the program is incorporated, the circuit being adapted to execute or to be used in the execution of the method in question.

### BRIEF DESCRIPTION OF THE DRAWINGS

Other characteristics and advantages appear on reading about implementations described with reference to the drawings, in which:

FIG. 1 shows a communications network having first and second pieces of equipment exchanging a time synchronization reference;

FIG. 2 shows the steps of a method of updating time synchronization in a first implementation of the invention;

FIG. 3 shows the steps of the method of updating time synchronization in a second implementation of the invention; and

FIG. 4 shows the steps of the method of updating time synchronization in a third implementation of the invention.

### DETAILED DESCRIPTION OF ILLUSTRATIVE EMBODIMENTS

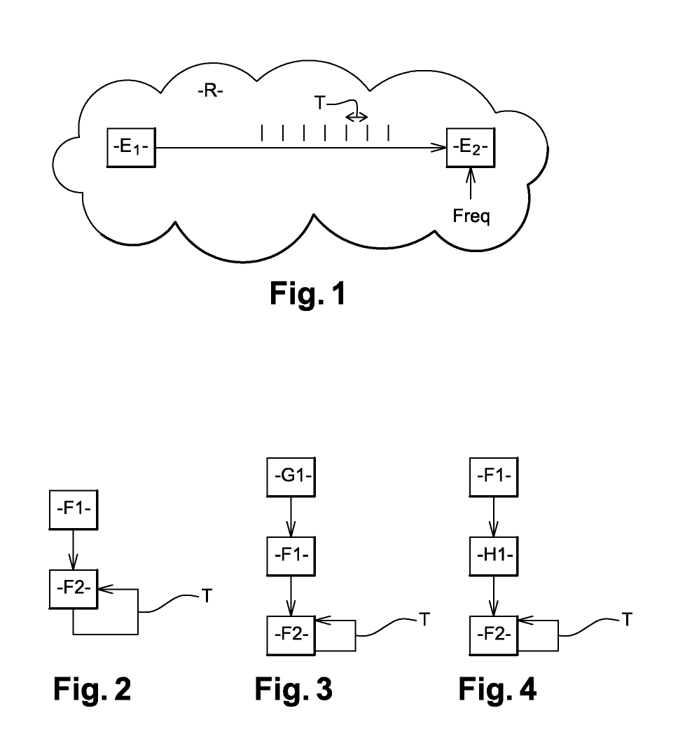

FIG. 1 shows a communications network R in which a method is performed for updating a time synchronization reference exchanged between a first piece of equipment E₁ and at least one second piece of equipment E₂ forming parts of the network R. This makes it possible to achieve time synchronization between the equipment E₂ and the equipment E₁.

Thus, the equipment E₂ receives a time synchronization reference transmitted by the equipment E₁ in periodic manner, e.g. once every T seconds (s), with the equipment E₁ being connected for example to a time synchronization source such as a GPS module (not shown in FIG. 1). As an additional example, the time synchronization source may be received from some other piece of equipment upstream from the equipment E₁, and not shown in FIG. 1.

An example of a protocol enabling the equipment E₂ to be synchronized is the PTPv2 protocol. Such a protocol is based on exchanging PTP type messages between the equipment E₁ and the equipment E₂ in order to transfer timing information such as time stamps.

Such PTP messages are exchanged between the equipment E₁ and the equipment E₂, and also between the equipment E₂ and the equipment E₁ in order to estimate the transmission time of PTP messages through the network R. Once the transmission time for PTP messages is known, it can then be compensated, in particular for PTP messages transmitted from the equipment E₁ to the equipment E₂, so that the equipment E₂ is correctly synchronized with the equipment E₁.

At the end of this exchange of PTP messages between the equipment E₁ and the equipment E₂, the equipment E₂ is synchronized with the equipment E₁. In a particular implementation of the invention, such synchronization of the equipment E₂ may be performed progressively so as to avoid too sudden a change in the time synchronization reference of the equipment E₂. This exchange of PTP messages between the equipment E₁ and the equipment E₂ is repeated periodically every T seconds so as to keep the equipment E₂ synchronized with the equipment E₁.

Between two time synchronization updates, the equipment E₂ must maintain its time synchronization reference so as to remain synchronized with the equipment E₁.

For this purpose, the equipment E₂ receives a frequency synchronization reference Freq that is transmitted by a frequency synchronization source.

In a first embodiment of the invention, the frequency synchronization reference Freq is transmitted by the equipment E₁ to the equipment E₂ via frequency synchronization transported by the physical layer. It should naturally be understood that a frequency synchronization reference and also information relating to its traceability may be received by the equipment E₁ from some other piece of equipment.

In an option, information relating to the traceability of the frequency synchronization reference Freq is transmitted to the equipment E₂ together with the frequency synchronization reference Freq.

In the situation where the equipment E₁ does not have a frequency synchronization source, the equipment E₁ includes previously configured information relating to the traceability of the frequency synchronization reference Freq. This configuration may also be implemented on receiving information about traceability.

In a first variant of the first implementation of the invention, the equipment E₁ receives the frequency synchronization reference Freq from an external frequency synchronization source.

In a second variant of the first implementation, the equipment E₁ includes a local oscillator that is not locked on an external reference (in free-running mode) and that provides frequency synchronization. Under such circumstances, the equipment E₁ includes previously configured information relating to the traceability of the frequency synchronization reference Freq.

In a second implementation of the invention, the equipment E₂ deduces a frequency synchronization reference Freq from PTP messages that may serve to maintain a reference frequency. The various ways in which the equipment E₁ can obtain the frequency synchronization reference remain applicable.

In a third implementation of the invention, the equipment E₂ may have access to a frequency synchronization reference Freq that is stable and exact via an external frequency source connected to the equipment E₂.

In order to reduce the periodicity for updating the time synchronization reference of the equipment E₂, and thus reduce the quantity of messages exchanged between the pieces of equipment E₁ and E₂ over the network, it is advantageous to adapt the periodicity T of the time synchronization updates. This makes it possible to take into consideration not only a time synchronization target to be achieved, but also the rate of drift of the time synchronization reference of the equipment E₂ between two updates.

In order to adapt the periodicity for updating the time synchronization reference as well as possible, it is advantageous to take into consideration the traceability of the frequency synchronization reference Freq.

For this purpose, the periodicity for updating the time synchronization reference of the equipment E₂ is determined as a function of information about the traceability of the frequency synchronization reference Freq.

Thus, with reference to FIG. 2, a piece of equipment E₁ forming part of the network R performs a step F1 of a method of updating the time synchronization reference of the equipment E₂, during which step the equipment determines the periodicity for updating the time synchronization reference as a function of the traceability information relating to the frequency synchronization reference.

In order to determine the periodicity for updating the time synchronization reference, it is possible to consult a table stored in the equipment that performs the determination step F1.

By way of example, such a table provides correspondence between the traceability information relating to the frequency synchronization reference Freq and a value for the periodicity T for updating the time synchronization reference.

Thus, for example, for a target time synchronization accuracy of 50 nanoseconds (ns) in the equipment E₂, the table may include the following entries:
for a frequency synchronization reference having traceability of one PRC, i.e. a drift of 0.01 parts per billion (ppb), which corresponds to accumulating phase error at 0.01 nanoseconds per second (ns/s), the duration of periodicity T is 5000 s;
for a frequency synchronization reference having traceability of one SSU, i.e. a drift of 10 ppb which corresponds to accumulating phase error of 10 ns/s, the duration of the periodicity T is 5 s; and
for a frequency synchronization reference having traceability of 1 SDH equipment clock per synchronization Ethernet equipment clock (SEC/EEC), i.e. a drift of 4.6 parts per million (ppm), this corresponds to accumulating phase error of 4.6 microseconds per second (μs/s), the duration of the periodicity is about one hundredth of a second.

During a step F2, the equipment E₁ transmits a time synchronization update to the equipment E₂ as a function of the periodicity T as determined during step F1.

In the first and second implementations of the invention, the equipment E₁ implements the determination step F1. In the first implementation, the equipment E₁ obtains the traceability information relating to the frequency synchronization reference Freq and determines the periodicity for updating the time synchronization reference by consulting the correspondence table. The equipment E₁ then sends the frequency synchronization reference to the equipment E₂, together with the traceability information and possibly also the periodicity for updating the time synchronization reference. It can thus be seen that the equipment E₂ receives the traceability information and can in turn perform the method of an embodiment of the invention in order to determine the periodicity for updating the time synchronization reference for some other piece of equipment, not shown in FIG. 1.

In the third implementation of the invention, the frequency synchronization reference Freq is delivered by an external frequency source connected directly to the equipment E₂.

In a first variant of this third implementation of the invention, shown in FIG. 3, the equipment E₂ acts during a step G1 to send the traceability information relating to the frequency synchronization reference Freq to the equipment E₁.

On receiving the traceability information relating to the frequency synchronization reference Freq, the equipment E₁ performs the determination step F1 and then the transmission step F2 as a function of the periodicity T as determined during the step F1.

Thus, in this first variant of the third implementation of the invention, the periodicity for updating the time synchronization reference is adapted at the request of the equipment E₂, which knows the traceability information relating to the frequency synchronization reference Freq.

In a second variant of this third implementation of the invention, as shown in FIG. 4, the equipment E₂ performs the determination step F1. Then, during a step H1, the equipment E₂ transmits the determined periodicity for updating the time synchronization reference to the equipment E₁.

In this second variant, the equipment E₂ includes means for determining the periodicity, such as the correspondence table. Once the periodicity for updating the time synchronization reference has been determined, the equipment E₂ informs the equipment E₁.

For this purpose, the equipment E₂ explicitly requests the equipment E₁ to send time synchronization updates with a given periodicity. Thus, during the step F2, the equipment

E₁ transmits the time synchronization update to the equipment E₂ as a function of the periodicity T as determined by the equipment E₂ during the step F1.

In other variant embodiments of the invention, the equipment E₂ can request the equipment E₁ to transmit time synchronization updates at a given periodicity T′ that is different from the periodicity determined during the step F1. This enables the equipment E₂ to maintain time synchronization, e.g. when it is not correctly receiving the frequency synchronization reference Freq. The periodicity T′ is determined as a function of the quality of a time synchronization source included in the equipment E₂. Such a time synchronization source may consist for example in a local oscillator that is not locked on an external reference (in free-running mode).

An embodiment of the invention also finds an application in the event of a breakdown in the equipment E₁ or in intermediate equipment serving to relay time synchronization between the equipment E₁ and the equipment E₂.

Under such circumstances, the equipment E₂ no longer receives time synchronization updates from the primary time synchronization source. The time synchronization from the primary time synchronization source is normally transmitted successively by all of the intermediate pieces of equipment until it reaches the equipment E₂, i.e. so long as there is not a failure in the network. The frequency synchronization reference Freq then makes it possible for each of the intermediate pieces of equipment that receives it to maintain time synchronization with the equipment E₁.

This type of situation can occur in the event of a failure of the time synchronization source, or indeed in the event of a problem in transmitting the time synchronization via the network R.

Combining time synchronization with a frequency synchronization reference Freq presents the advantage of making it possible to increase the time during which the equipment E₂, or any intermediate piece of equipment, can remain synchronized with the equipment E₁ without receiving the time synchronization update.

In the event of a failure in intermediate equipment, it may be advantageous to stop sending time synchronization updates to the equipment E₂. It is no longer of any use to continue transmitting time synchronization from intermediate equipment that no longer has access to the primary time synchronization reference when a frequency synchronization reference Freq is accessible to all of the intermediate pieces of equipment situated between the intermediate equipment where the failure is detected and the equipment E₂.

Receiving the frequency synchronization reference Freq in each of these intermediate pieces of equipment and in the equipment E₂ enables them to maintain their own local time synchronization references throughout the duration of the fault.

Although the present disclosure has been described with reference to one or more examples, workers skilled in the art will recognize that changes may be made in form and detail without departing from the scope of the disclosure and/or the appended claims.

1. An updating method for updating a time synchronization reference exchanged between a first piece of equipment and at least one second piece of equipment forming parts of a communications network, the method comprising the following steps performed by one of the pieces of equipment:
a reception step of receiving traceability information relating to a frequency synchronization reference; and
a determination step of determining a periodicity for updating the time synchronization reference as a function of said received traceability information, said updating enabling the time synchronization reference of the second piece of equipment to be maintained.

2. The updating method according to claim 1, wherein the traceability information is sent by the second piece of equipment to the first piece of equipment.

3. The updating method according to claim 1, in which the reception and determination steps are performed by the second piece of equipment, said method also including a step of the second piece of equipment transmitting a message to the first piece of equipment, the message including the periodicity for updating the time synchronization reference.

4. The updating method according to claim 1, wherein the reception and determination steps are performed by the first piece of equipment, said method further including a step of sending the frequency synchronization reference and the associated traceability information to the second piece of equipment.

5. A piece of equipment suitable for exchanging a time synchronization reference with at least one other piece of equipment forming part of a communications network, the equipment comprising:
reception means for receiving traceability information relating to a frequency synchronization reference; and
determination means for determining a periodicity for updating the time synchronization reference as a function of received traceability information, said updating enabling the time synchronization reference of the other piece of equipment to be maintained.

6. The piece of equipment according to claim 5, further including means for transmitting a message containing the periodicity for updating the time synchronization reference.

7. A communications network comprising:
at least a first piece of equipment suitable for exchanging a time synchronization reference with at least one second piece of equipment, the first piece of equipment having:
reception means for receiving traceability information relating to a frequency synchronization reference; and
determination means for determining a periodicity for updating the time synchronization reference as a function of received traceability information, enabling the time synchronization reference of the second piece of equipment to be maintained.

8. A non-transitory computer-readable medium comprising a computer program recorded thereon and including program code instructions for implementing steps of an updating method when the program is executed by a processor, wherein the updating method updates a time synchronization reference exchanged between a first piece of equipment and at least one second piece of equipment forming parts of a communications network, the method comprising the following steps performed by one of the pieces of equipment:
a reception step of receiving traceability information relating to a frequency synchronization reference; and
a determination step of determining a periodicity for updating the time synchronization reference as a function of said received traceability information, said updating enabling the time synchronization reference of the second piece of equipment to be maintained.

9. The non-transitory computer-readable medium of claim 8, wherein the medium is coupled to switching equipment, which constitutes the piece of equipment that performs the steps of the method.
